(19) United States
(12) Patent Application Publication
(10) Pub. No.: US 2016/0129395 A1
(43) Pub. Date: May 12, 2016

(54) FLUE GAS TREATMENT SYSTEM AND FLUE GAS TREATMENT METHOD

(71) Applicant: MITSUBISHI HITACHI POWER SYSTEMS, LTD., Kanagawa (JP)

(72) Inventors: Tomotsugu MASUDA, Kanagawa (JP); Takahito MIYOSHI, Kanagawa (JP); Koji HIGASHINO, Tokyo (JP)

(73) Assignee: MITSUBISHI HITACHI POWER SYSTEMS, LTD., Kanagawa (JP)

(21) Appl. No.: 14/888,113

(22) PCT Filed: Jun. 17, 2015
(86) PCT No.: PCT/JP2015/067447

§ 371 Date: Oct. 30, 2015

(30) Foreign Application Priority Data
Nov. 7, 2014 (JP) 2014-227579

(51) Int. Cl. B01D 53/86; B01D 53/34; B03C 3/017

(52) U.S. Cl. CPC B01D 53/8637; B03C 3/017; B01D 53/869; B01D 53/343; B01D 53/8609; B01D 2255/20707; B01D 2255/65; B01D 2255/40

(57) ABSTRACT

The present invention provides a flue gas treatment system and a flue gas treatment method that enable the stable long-term operation of a plant by reducing NOₓ in a combustion flue gas and reducing the concentration of SO₃ more compared with that available conventionally. The flue gas treatment method of removing NOₓ and SO₃ in the gas that includes NOₓ and SO₃ includes a denitration and SO₃ reduction step of denitrating the gas and reducing SO₃ into SO₂, in which NH₃ as a first additive and a second additive including one or more selected from the group consisting of an olefinic hydrocarbon expressed by a general formula: CₙH₂, (n is an integer of 2 to 4) and a paraffinic hydrocarbon expressed by a general formula: CₘH₂ₘ₊₂ (m is an integer of 2 to 4) are added to the gas before bringing the gas into contact with a catalyst.

### TECHNICAL FIELD

The present invention relates to a flue gas treatment system and to a flue gas treatment method, and more specifically, relates to a flue gas treatment system and a flue gas treatment method for treating combustion flue gases including sulfur trioxide generated in coal-fired power generation plants or low-grade fuel-fired power generation plants.

### BACKGROUND ART

In recent years, a flue gas treatment system and a flue gas treatment method that treat combustion flue gases combusted in various types of furnaces for power generation plants such as coal-fired power generation plants and low-grade fuel-fired power generation plants have been strongly desired in order to prevent air pollution. Such flue gases contain nitrogen oxides (NOₓ) and a large amount of sulfur oxides (SOₓ), and in order to treat them, a denitration apparatus, a precipitator, a desulfurization apparatus, and the like are installed in plants. However, among SOₓ, sulfur trioxides (SO₃) are corrosive and are a factor that inhibits stable operation and long-term operation of power generation plants.

For a method of treating such SO₃, a method has been known in which ammonium (NH₃) is charged to a combustion flue gas as a reductant, then the combustion flue gas is brought into contact with a denitration catalyst constituted by ruthenium (Ru) carried on titania (TiO₂), and thereby NOₓ is reduced and generation of SO₃ in combustion flue gases is prevented by a reaction expressed by the following expression (1) (Patent Literature 1). In addition, another method has been known, in which the reduction ratio of SO₃ is improved by using such a denitration catalyst produced in a form in which Ru is carried on a carrier constituted by two of titania, silica (SiO₂), and tungsten oxide (WO₃) and the remaining one is coated as a base material (Patent Literature 2).

[Chemical Formula 1]

SO₃+2NH₃+O₂→SO₂+N₂+3H₂O (1)

However, even in the exemplary cases recited in Patent Literatures 1 and 2, the oxidation reaction expressed by the following expression (2) predominantly progresses during treatment of combustion flue gases, and therefore the concentration of SO₃ may increase. In addition, failures may thus occur within the system, and it is necessary to stop the operation of the plant every time such a failure occurs, and therefore, stable operation, long-term operation, and the like of the plant may be affected.

[Chemical Formula 2]

SO₂+½O₂→SO₃ (2)

### CITATION LIST

### Patent Literature

[Patent Literature 1] JP 3495591

[Patent Literature 2] JP 4813830

### SUMMARY OF INVENTION

### Technical Problem

Under these circumstances, an object of the present invention is to provide a flue gas treatment system and a flue gas treatment method that reduces treatment costs, reduces NOₓ contained in a combustion flue gas in an oxygen atmosphere, and reduces the concentration of SO₃ compared to that available conventionally, and thus, enables stable long-term operation of a plant.

### Solution to Problem

In order to achieve the above-described object, according to an aspect of the present invention, a flue gas treatment system is a flue gas treatment system which removes NOₓ and SO₃ in a combustion flue gas that includes NOₓ and SO₃, and the system includes a denitration and SO₃ reduction apparatus configured to denitrate the combustion flue gas and reduce SO₃ into SO₂ by adding NH₃ that is a first additive and a second additive including one or more selected from the group consisting of an olefinic hydrocarbon expressed by a general formula: Cₙ,H₂ₙ (n is an integer of 2 to 4) and a paraffinic hydrocarbon expressed by a general formula: CₘH₂ₘ₊₂ (m is an integer of 2 to 4) to the combustion flue gas before bringing the combustion flue gas into contact with a catalyst. Note that in descriptions given herein and in the claims, the term “and/or” is used, in conformity with JIS Z 8301, to collectively express a combination of two terms used in parallel to each other and either one of the two terms, i.e., to collectively express the three possible meanings that can be expressed by the two terms.

In addition, the second additive may be an olefinic hydrocarbon having an allyl structure, and C₃H₆ is preferable as the olefinic hydrocarbon.

In addition, it is preferable that the load of the C₃H₆ be 0.1 to 2.0 by molar ratio of C₃H₆/SO₃.

The catalyst may include an oxide, a mixed oxide, or a complex oxide selected from the group consisting of TiO₂, TiO₂—SiO₂, TiO₂—ZrO₂, and TiO₂—CeO₂ as a carrier. It is preferable that SiO₂ in the TiO₂—SiO₂ complex oxide be contained within a range of 5% to 60% by a percentage ratio of

SiO₂/(TiO₂+SiO₂).

According to another aspect of the present invention, the flue gas treatment system may further include an air preheater arranged on a back stream side of the denitration and SO₃ reduction apparatus and configured to recover heat from the combustion flue gas; an electric precipitator arranged on a back stream side of the air preheater and configured to collect dust from the combustion flue gas; and a denitration apparatus arranged on a back stream side of the electric precipitator and configured to absorb and remove SO₂ remaining in the combustion flue gas or obtained by reducing SO₃ by bringing the SO₂ into contact with slurry formed from calcium carbonate.

According to yet another aspect of the present invention, in the flue gas treatment system, the combustion flue gas may be a flue gas from a low-grade fuel-fired power generation plant, and the system may further include a third addition device arranged on a front stream side of the electric precipitator and configured to further add NH₃ and/or CaCO₃ to the combustion flue gas including SO₃ remaining therein as a third additive.

Further, according to yet another aspect of the present invention, the present invention is a flue gas treatment method. The flue gas treatment method according to yet another aspect of the present invention is a flue gas treatment method for removing NOₓ and SO₃ in a combustion flue gas including NOₓ and SO₃, and the method includes a denitration and SO₃ reduction step of denitrating the combustion flue gas and reducing SO₃ into SO₂, in which NH₃ that is a first additive and a second additive including one or more selected from the group consisting of an olefinic hydrocarbon expressed by a general formula: CₙH₂ₙ (n is an integer of 2 to 4) and a paraffinic hydrocarbon expressed by a general formula: CₘH₂ₘ₊₂ (m is an integer of 2 to 4) are added to the combustion flue gas before bringing the combustion flue gas into contact with a catalyst.

### Advantageous Effects of Invention

According to the present invention, a flue gas treatment system and a flue gas treatment method are provided, which enable the stable long-term operation of a plant by reducing NOₓ in a combustion flue gas and reducing the concentration of SO₃ more compared with that conventionally available.

### BRIEF DESCRIPTION OF DRAWINGS

FIG. 1 is a schematic diagram showing a first embodiment of the flue gas treatment system and the flue gas treatment method according to the present invention.

FIG. 2 is a schematic diagram showing a second embodiment of the flue gas treatment system and the flue gas treatment method according to the present invention.

FIG. 3 is a view showing a denitration effect and an effect of reducing SO₃ into SO₂ by an SO₃ reductant (C₃H₆/SO₃=2) by a simulation of an actual machine for Example 1 of the flue gas treatment system and the flue gas treatment method according to the present invention.

FIG. 4 is a view showing continuous operation time of an air preheater (AH) by a simulation of an actual machine for different levels of concentration of SO₃ in a combustion flue gas for Example 1 of the flue gas treatment system and the flue gas treatment method according to the present invention.

FIG. 5 is a view showing a denitration effect and an effect of reducing SO₃ into SO₂ by an SO₃ reductant (C₃H₆/SO₃=2) by a simulation of an actual machine for Example 2 of the flue gas treatment system and the flue gas treatment method according to the present invention.

FIG. 6 is a view showing continuous operation time of an electric precipitator (EP) by a simulation of an actual machine for different levels of concentration of SO₃ in a combustion flue gas for Example 1 of the flue gas treatment system and the flue gas treatment method according to the present invention.

FIG. 7 is a view showing a denitration effect and an effect of reducing SO₃ into SO₂ by an SO₃ reductant (C₃H₆/SO₃=0.5) by a simulation of an actual machine for Example 3 of the flue gas treatment system and the flue gas treatment method according to the present invention.

FIG. 8 is a view showing a denitration effect and an effect of reducing SO₃ into SO₂ by an SO₃ reductant (C₃H₆/SO₃=0.9) by a simulation of an actual machine for Example 3 of the flue gas treatment system and the flue gas treatment method according to the present invention.

FIG. 9 is a view showing a denitration effect and an effect of reducing SO₃ into SO₂ by an SO₃ reductant (C₃H₆/SO₃=2) by a simulation of an actual machine for Example 4 of the flue gas treatment system and the flue gas treatment method according to the present invention.

FIG. 10 is a view showing a relationship between a catalyst composition and the rate of oxidation of SO₂ into SO₃ for Example 4 of the flue gas treatment system and the flue gas treatment method according to the present invention.

FIG. 11 is a view showing an effect of reducing SO₃ to SO₂ by an SO₃ reductant (C₃H₆/SO₃=2) by a simulation of an actual machine for Example 5 of the flue gas treatment system and the flue gas treatment method according to the present invention.

FIG. 12(a) is a view showing an increase ratio of pressure drop ratio in a conventional actual machine for Example 6 of the flue gas treatment system and the flue gas treatment method according to the present invention, and FIG. 12(b) is a view showing the concentration of SO₃ and the concentration of leaked NH₃ in a conventional actual machine.

FIG. 13(a) is a view showing an increase ratio of assumed pressure drop ratio when an SO₃ reductant is used in a conventional actual machine for Example 6 of the flue gas treatment system and the flue gas treatment method according to the present invention, and FIG. 13(b) is a view which shows an assumed concentration of SO₃ and an assumed concentration of leaked NH₃ when an SO₃ reductant is used in an actual machine.

FIG. 14 is a view showing variation of the concentration of SO₃ in a combustion flue gas for Example 7 of the flue gas treatment system and the flue gas treatment method according to the present invention.

FIG. 15 is a view showing a ratio of reduction of SO₃ obtained when a SO₃ reductant is used for Example 8 of the flue gas treatment system and the flue gas treatment method according to the present invention.

FIG. 16 is a view showing a relationship between decomposition activation energy of the SO₃ reductant and SO₃ reduction rate constant for Example 8 of the flue gas treatment system and the flue gas treatment method according to the present invention.

### DESCRIPTION OF EMBODIMENTS

The flue gas treatment system and the flue gas treatment method according to the present invention will be described below with reference to embodiments shown in attached drawings. A flue gas combusted in a furnace of a boiler in an oxygen atmosphere such as a presence of oxygen will be referred to as a “combustion flue gas”. The stream of gas is herein referred to as a “front stream” or “back stream” in relation to the direction of flow of a combustion flue gas.

### [Flue Gas Treatment System]

### First Embodiment

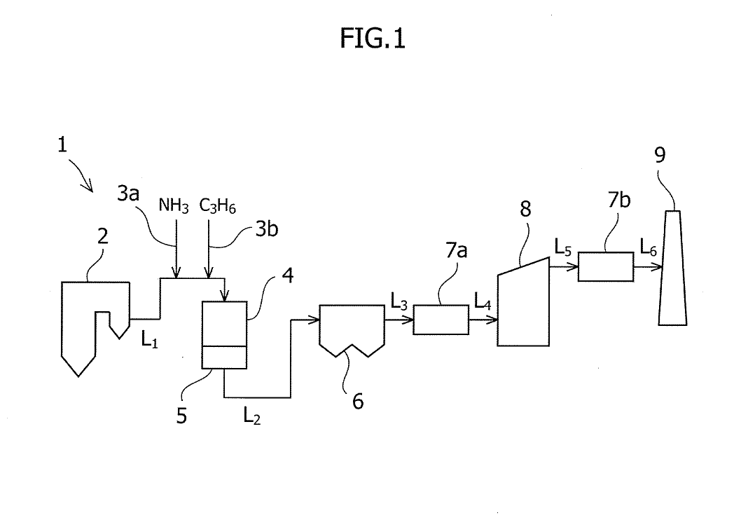

A first embodiment of the flue gas treatment system according to the present invention will be described with reference to FIG. 1. Referring to

FIG. 1, a flue gas treatment system 1 shown in FIG. 1 is installed in a coal-fired power generation plant and at least includes a boiler 2; a first addition device 3a; a second addition device 3b; a denitration apparatus 4; an air preheater 5; a precipitator 6; heat recovery and reheating devices 7a and 7b; a desulfurization apparatus 8; and a stack 9. Note that a configuration at least constituted by at least the first addition device 3a, the second addition device 3b, and the denitration apparatus 4 is herein, and in claims, referred to as a denitration and SO₃ reduction apparatus.

The boiler 2 combusts an externally fed boiler fuel in a furnace and feeds combustion flue gases generated by the combustion to the denitration apparatus 4. The flue gas generated by combustion at least includes SO₃ generated by oxidation of SO₂.

The first addition device 3a is an injection pipe installed on a front stream side of the denitration apparatus 4 and injects ammonia (NH₃), which is a first additive, into the combustion flue gas. The first addition device 3a injects ammonia to denitrate nitrogen oxides in a flue gas by selective catalytic reduction.

The second addition device 3b is an injection pipe installed closely to the first addition device 3a on a front stream side of the denitration apparatus 4 and injects a second additive into the flue gas. The second addition device 3b collaborates with the denitration apparatus 4 to reduce SO₃ in the combustion flue gas into SO₂ and reduce the concentration of SO₃ in the combustion flue gas. In addition to the form of injection pipes, a plurality of spray nozzles can be used as the form of the first and the second addition devices 3a and 3b, and a plurality of nozzles arranged along the direction of flow of the combustion flue gas is suitable. The second addition device 3b herein, and in the claims, is also referred to as an “SO₃ reductant injection device”.

The second additive injected from the second addition device 3b is an SO₃ reductant which primarily SO₃ can be reduced into SO₂, and is one or more selected from the group consisting of olefinic hydrocarbons (unsaturated hydrocarbons) expressed by general formula: CₙH₂ₙ (n is an integer of 2 to 4) and paraffinic hydrocarbons (saturated hydrocarbons) expressed by general formula CₘH₂ₘ₊₂ (m is an integer of 2 to 4). The hydrocarbons may be used alone or in a combination of one or more when necessary. For the second additive, one or more selected from the group consisting of propane (C₃H₈), ethylene (C₂H₄), propylene (C₃H₆), and butene (C₄H₈) are preferable; one or more selected from the group consisting of the group consisting of C₃H₆ and C₄H₈ are more preferable; and one or more selected from the group consisting of C₃H₆, which is a hydrocarbon compound with an aryl structure (CH₂═CH—CH₂—), 2-butene such as cis-2-butene and trans-2-butene, and isobutene (iso-C₄H₈) are yet more preferable, and C₃H₆ is particularly preferable. With this configuration, SO₃ can be reduced into SO₂ in an oxygen atmosphere and thus the concentration of SO₃ in a combustion flue gas can be reduced.

If C₃H₆ is used as the second additive, it is preferable that the load of the second additive be 0.1 to 2.0 by molar ratio of C₃H₆/SO₃. If the molar ratio of the second additive is less than 0.1, the oxidation of SO₂ may become predominant and thus SO₃ may abruptly increase, and in contrast, if the molar ratio of the second additive is more than 2.0, then a large amount of unreacted excessive C₃H₆ may be discharged. By controlling the amount of the second additive in the above-described range, the performance of eliminating SO₃ in the combustion flue gas can be improved. Note that the effect of removing SO₃ can be obtained outside the range specified above.

The denitration apparatus 4 is arranged on a back stream side of the first and the second addition devices 3a and 3b, and a known selective catalytic reduction (SCR) apparatus installed in existing plants can be employed. The denitration apparatus 4 includes a denitration catalyst and brings a combustion flue gas including the first additive into contact with the denitration catalyst. After the contact with the denitration catalyst, NOX such as NO and NO₂ in the combustion flue gas are decomposed into nitrogen and steam to be denitrated by reactions expressed by the following expressions (3) to (5). If a denitration catalyst including a denitration active component such as vanadium oxide (V₂O₅) is used as the denitration apparatus 4, the efficiency of denitration becomes high but oxidation of SO₂ may progress.

[Chemical Formula 3]

NO+NH₃+ 1/40₂→N₂+ 3/2H₂O (3)

NO₂+2NH₃+½O₂→ 3/2N₂+3H₂O (4)

NO+NO₂+2NH₃→2N₂+3H₂O (5)

In addition, the denitration apparatus 4 according to the present embodiment reduces SO₃ in the combustion flue gas into SO₂ by collaboration with the second addition device 3b and thus reduces the concentration of SO₃ in the combustion flue gas by reactions expressed by the following expressions (6) to (11).

[Chemical Formula 4]

SO₃+CH₃OH+¾O₂→SO₂+½CO+½CO₂+2H₂O (6)

SO₃+C₂H₅OH+ 5/42O₂→SO₂+CO+CO₂+⅖H₂O (7)

SO₃+C₂H₄+ 5/2O₂→SO₂+CO+CO₂+2H₂O (8)

SO₃+ 3/2C₃H₆+4⅛3O₂→SO₂+ 9/4CO+ 9/4CO₂+6H₂O (9)

SO₃+ 3/2C₃H₈+6⅜O₂→SO₂+ 9/4CO+ 9/4CO₂+6H₂O (10)

SO₃+ 3/2C₄H₈+1 3/2O₂→SO₂+3CO+3CO₂+6H₂O (11)

The denitration apparatus 4 includes, in its inside, a catalyst structure constituted by one or more catalysts combined together in a plurality of layers. In the present embodiment, the number of catalyst layers in the denitration apparatus 4 can be increased and the catalyst can be regenerated for the denitration apparatus 4. By increasing the number of the catalyst layers and by carrying out regeneration of the catalysts, the rate of oxidation of SO₂ in the denitration apparatus increases, and thus the concentration of SO₃ in the flue gas increases. However, in the present embodiment, the decrease of the amount of reduction of SO₃ can be greater than the increase of the concentration of SO₃ in the flue gas. Accordingly, even if the number of the catalyst layers is increased and the catalysts are regenerated, the concentration of SO₃ can be reduced.

The catalyst is a catalyst in which the active component is carried on a carrier which is an oxide, a mixed oxide, and/or a composite oxide. More specifically, examples of the carrier include an oxide of one or more of elements selected from the group consisting of titanium (Ti), silicon (Si), zirconium (Zr), and cerium (Ce) and/or a mixed oxide and/or a composite oxide of two or more of elements selected from the above group. Among them, it is preferable that the carrier be an oxide or a mixed oxide or a composite oxide selected from the group consisting of TiO₂, TiO₂—SiO₂, TiO₂—ZrO₂, and TiO₂—CeO₂, and it is more preferable that the carrier be a composite oxide of TiO₂ or TiO₂-SiO₂.

It is preferable that SiO₂ in the TiO₂—SiO₂ complex oxide be 5% to 60%, more preferably 12% to 21%, by a percentage ratio of SiO₂/(TiO₂+SiO₂). By controlling the amount of SiO₂ in a TiO₂—SiO₂ complex oxide in the above-described range, oxidation of SO₂ can be suppressed and the effect of the second additive for reducing SO₃ into SO₂ can be improved even at the same amount of the carried active component. If the above ratio is 5% or less, the effect of suppressing oxidation of SO₂ may not be achieved. Note that herein, and in the claims, the term “percentage ratio” refers to a ratio of the weight of SiO₂ versus 100 for the total weight (wt.) of TiO₂ and SiO₂, and the term “weight” can be substituted by a term “mass”.

The catalyst can be a honeycomb structure body. However, the shape of the catalyst is not limited to this, and examples of the shape of the catalyst include a spherical shape, a cylindrical shape, a powder body, a porous flat plate body, and the like. The complex oxide can be prepared by a process in which an alkoxide compound a chloride, a sulfate, or an acetate of the above-described elements is mixed, then the resulting mixture is further mixed with water and then stirred in the form of an aqueous solution or sol for hydrolysis. The complex oxide may also be prepared by a known coprecipitation process instead of the above-described sol-gel process.

The active component is a metal oxide of one or more selected from the group consisting of vanadium oxide (V₂O₅), tungsten oxide (WO₃), molybdenum oxide (MoO₃), manganese oxide (Mn₂O₃), manganese dioxide (MnO₂), nickel oxide (NiO), and cobalt oxide (CO₃O₄). With this configuration, an active metal carried by the catalyst acts as an active site, and thus increase of SO₃ in the combustion flue gas can be prevented in an oxygen atmosphere without using expensive metals such as ruthenium (Ru) and the denitration of NOₓ such as NO₂ can be efficiently performed in an oxygen atmosphere. It is preferable that the active component, among these metal oxides, be one or more selected from the group consisting of vanadium oxide (V₂O₅), molybdenum oxide (MoO₃), and tungsten oxide (WO₃).

It is preferable that a catalytic reaction by the denitration apparatus 4 be carried out within a temperature range of 250° C. to 450° C., more preferably 300° C. to 400° C. If the temperature is 300° C. or less, the performance of the catalyst may degrade due to degradation of the catalyst in the denitration apparatus 4, and in contrast, if the temperature exceeds 400° C., the second additive may be self-degraded and thus poor reduction of SO₃ may occur.

Note that the catalyst can be produced by applying a method known per se as a method basically used in producing a denitration catalyst. In addition, the concentration of SO₃ in a combustion flue gas can be reduced by reducing SO₃ to SO₂. Accordingly, a configuration may be employed in which the denitration activity the catalyst itself and the rate of oxidation of SO₂ are increased and the catalyst amount is reduced in accordance with the level of reduction of SO₃.

The air preheater 5 is arranged on a back stream side of the denitration apparatus 4, and an air preheater (AH) installed in an existing plant can be employed. The air preheater 5 is provided with a heat transfer element for introducing combustion air into the boiler 2, and recovers the heat from the combustion flue gas by heat exchange between the combustion flue gas and the combustion air by using the heat transfer element. By performing the heat recovery, the temperature of the combustion flue gas is lowered to a predetermined temperature and the temperature of the combustion air is increased, and thus the efficiency of combustion in the boiler is improved. In the present embodiment, the concentration of SO₃ flowing into the air preheater 5 has been decreased. With this configuration, the SO₃ in the combustion flue gas is converted into gaseous or mist-like concentrated sulfuric acid (H₂SO₄) by a reaction with H₂O as expressed by the following expression (12), and thus corrosion of metallic members and increase of the amount of accumulated ash, which may occur due to such corrosion, can be suppressed.

[Chemical Formula 5]

SO₃+H₂O→H₂SO₄ (12)

Further, if SO₃ exists in the flue gas in the air preheater 5 at a high concentration, a part of the SO₃ may be condensed due to the metal members provided inside the air preheater 5, which may promote corrosion of the metal members and the like and accumulation of ash. As a result, conventionally, the pressure drop inside the air preheater 5 may increase, and it is necessary to stop the operation of the plant for maintenance operations such as washing with water. According to the present embodiment, SO₃ in the flue gas which flows into the air preheater 5 is reduced, thus the concentration of SO₃ is decreased, and therefore the problems described above can be suppressed and stable and long-term operation of the plant is thus enabled. In addition, the air preheater 5 can optionally include a thermometer (not shown). If this configuration is employed, the metal temperature of the metallic members and the moisture content in the combustion flue gas are estimated and the pressure drop in the air preheater 5 and the concentration of SO₃ for enabling the stable operation are calculated, and according to result of the estimation and calculation, the amount of the second additive to be fed can be controlled so that the concentration of SO₃ is to be controlled at a threshold value or less, for example. With this configuration, the amount of the second additive can be reduced, and thus the running costs can be reduced.

The precipitator 6 is arranged on a back stream side of the air preheater 5, and an electric precipitator (EP) or a bag filter installed in an existing plant can be employed. The precipitator 6 collects dust in the combustion flue gas by using an electric precipitation machine, bag filter, or the like. In the present embodiment, the concentration of SO₃ which flows into the precipitator 6 has decreased. Accordingly, corrosion of the precipitator 6 and the piping system thereof, adhesion of dust to electrodes, and poor charging and clogging by ash, which may occur due to the dust adhered to the electrodes, can be prevented. Accordingly, the precipitator 6 can be continuously operated, and thus the stable and long-term operation of the plant is enabled. In addition, installation of a wet type EP, which is installed if the concentration of SO₃ in the flue gas is high, would not be required.

The heat recovery/reheating device 7a is arranged on a front stream or on a back stream of the precipitator 6, and is a heat recovery device of a gas-gas-heater (GGH) installed in an existing plant. The heat recovery/reheating device 7a recovers heat from the combustion flue gas and cools the combustion flue gas by heat exchange. The heat recovery/reheating device 7a includes metal members such as a heat exchanger (not shown). In the present embodiment, because the concentration of SO₃ in the flue gas which flows into heat recovery/reheater 7a has been decreased, corrosion of metal members such as a heat exchanger arranged inside the heat recovery/reheating device can be suppressed and adhesion and accumulation of lime ash in the heat recovery/reheating device can also be suppressed.

The desulfurization apparatus 8 is arranged on a back stream side of the precipitator 6 and the heat recovery/reheater 7a, and is a flue-gas desulfurization (FGD) apparatus installed in an existing plant. The desulfurization apparatus 8 brings SO₂ remaining in the combustion flue gas or reduced SO₂ into contact with lime slurry formed by suspending limestone (calcium carbonate: CaCO₃) in water to absorb and remove the SO₂ by a reaction expressed by the following expression (13). In addition, the desulfurization apparatus 8 oxidizes the lime slurry that has absorbed SO₂ with air supplied through an air supply line (not shown) to form plaster slurry (CaSO₄/2H₂O) and collects and removes SO₂ in the form of plaster.

[Chemical Formula 6]

SO₂+CaCO₃+½H₂O→CaSO₃·½H₂O+CO₂ (13)

CaSO₂·½H₂O+½O₂+ 3/2H₂O→CaSO₄·2H₂O (14)

The heat recovery/reheating device 7b is arranged on a back stream side of the desulfurization apparatus 8, and is a reheater of a gas-gas-heater installed in an existing plant. The heat recovery/reheating device 7b reheats the combustion flue gas on a front stream side of the stack 9 with the heat recovered by the heat recovery/reheating device 7a. The heat recovery/reheating device 7b includes metal members such as a heat exchanger (not shown). In the present embodiment, the concentration of SO₃ in the flue gas which flows into heat recovery/reheater 7b has decreased. Accordingly, corrosion of metal members such as a heat exchanger arranged inside the heat recovery/reheating device 7b can be suppressed and adhesion and accumulation of lime ash in the heat recovery/reheating device can also be suppressed.

From the stack 9, treated combustion flue gas is discharged by using fans (not shown). The stack 9 is installed in an inside or an outside of the precipitator 6, and can have a configuration for discharging the treated combustion flue gas. In the present embodiment, the flue gas which flows into the stack 9 includes substantially no SO₃. Accordingly, SO₃ does not enter the stack 9, and thus emission of blue smoke can be prevented.

### [Flue Gas Treatment Method]

A first embodiment of the flue gas treatment method according to the present invention will be described with reference to its mode of operation of the first embodiment of the flue gas treatment system having the above-described configuration.

The flue gas treatment method according to the present embodiment is a flue gas treatment method of removing NOX and SO₃ in a flue gas in a coal-fired power generation plant, and at least includes a denitration and SO₃ reduction process, an air preheating process, a heat recovery and reheating process, a desulfurization process, and a discharge process.

In the denitration and SO₃ reduction process, before a combustion flue gas generated in the boiler 2 is brought into contact with the denitration catalyst, the first additive and the second additive are added to the combustion flue gas in a line L₁, and the combustion flue gas is denitrated by the denitration apparatus 4 to reduce SO₃ to SO₂. More specifically, the denitration and SO₃ reduction process includes a first addition process and a second addition process. In the first addition process, ammonia (NH₃), which is the first additive, is injected by the first addition device 3a into the flue gas supplied from the boiler 2 through L₁. In the second addition process, a compound including an H element and a C element, which is the second additive, is injected by the second addition device 3b. It is preferable that the first and the second addition processes be carried out in the line L₁ from the boiler 2 to the denitration apparatus 4 by using a plurality of nozzles arranged along the direction of flow of the combustion flue gas.

In addition, it is preferable that the first addition process and the second addition process be carried out at the same time. Note that for the method of adding the first and the second additives, a method can be employed in which air, inert gas, steam, and the like are added to the previously vaporized first and second additives and then the mixture is diluted before adding the additives, for example. Note that herein, and in the claims, the second addition process will also be referred to as an “SO₃ reduction process”.

In the air preheating process, heat is recovered from the flue gas that has undergone the denitration and SO₃ reduction process. More specifically, heat is recovered from the flue gas supplied from the denitration apparatus 4 by using the air preheater 5 by heat exchange to cool the combustion flue gas.

In the first heat recovery and reheating process, heat is recovered from the flue gas which has undergone the dust collection process to cool the combustion flue gas. More specifically, heat is recovered by the heat recovery/reheating device 7a from the flue gas supplied from the precipitator 6 through a line L₃ by heat exchange to cool the combustion flue gas.

In the desulfurization process, SO₂ remaining in the combustion flue gas which has undergone the first heat recovery and reheating process or SO₂ generated by reduction of SO₃ is brought into contact with slurry formed from calcium carbonate, and thereby such SO₂ is removed. More specifically, SO₂ remaining in the combustion flue gas supplied from the heat recovery/reheating device 7a through a line L₄ or SO₂ generated by reduction is brought into contact with lime slurry formed by suspending limestone (calcium carbonate: CaCO₃) in water, and thereby such SO₂ is absorbed and removed. In addition, the lime slurry which has absorbed SO₂ may also be treated by oxidation with the air supplied through an air supply line (not shown) to form plaster slurry (CaSO₄/2H₂O) to collect and remove such SO₂ in the form of plaster.

In the second heat recovery and reheating process, the flue gas which has undergone the desulfurization process is reheated. More specifically, the combustion flue gas supplied from the desulfurization apparatus 8 through a line L₅ is reheated by the heat recovery/reheating device 7b and the reheated combustion flue gas is fed into the stack 9 through a line L₆.

In the discharge process, the combustion flue gas treated by using a fan (not shown) after having undergone the second heat recovery and reheating process.

### [Flue Gas Treatment System]

### Second Embodiment

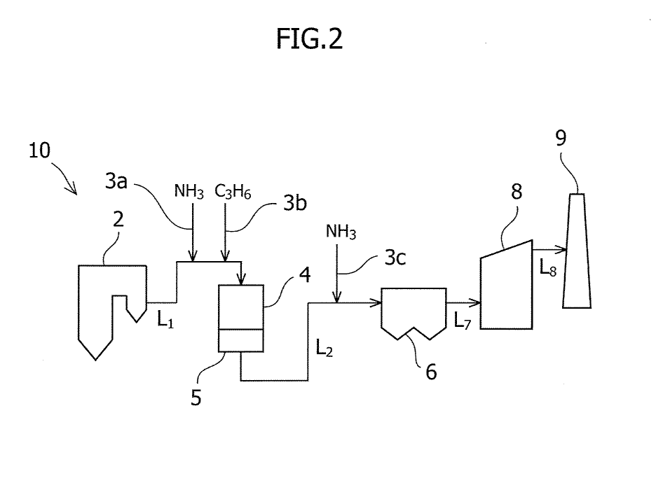

A second embodiment of the flue gas treatment system will be described with reference to FIG. 2. The components that are the same as those of the first embodiment are provided with the same reference numerals and symbols shown in FIG. 1 and detailed descriptions thereof will not be repeated below. Referring to FIG. 2, a flue gas treatment system 10 is different from the flue gas treatment system of the first embodiment at least in such points that it is installed in a low-grade fuel-fired power generation plant and that it includes a third addition apparatus 3c. The low-grade fuel includes heavy oil, petro coke, vacuum residue (VR), and low-grade coal.

For the third addition device 3c, an injection pipe installed in an existing plant, which is arranged on a back stream of the air preheater 5 and on a front stream of the precipitator 6, can be employed. The third addition device 3c further injects ammonia (NH₃), which is a third additive, to the combustion flue gas to which the first additive and the second additive have been added by the first addition device 3a and the second addition device 3b, on a front stream of the precipitator 6. When ammonia is injected by the third addition device 3c, SO₃ in the flue gas reacts with NH₃ by a reaction expressed by the following expression (15) and generates ammonium sulfate ((NH₄)HSO₄) in the form of solid particles. SO₃ is thereby collected together with dust.

[Chemical Formula 7]

SO₃+NH₃+H₂O→(NH₄)HSO₄ (15)

In the flue gas treatment system according to the second embodiment, the configuration is described in which the heat recovery/reheating device 7a and the heat recovery/reheating device 7b are not included as an example. However, the heat recovery/reheating device 7a and the heat recovery/reheating device 7b can be included according to requirements of the low-grade fuel-fired power generation plant such as the purpose of use and the like of the plant.

### [Flue Gas Treatment Method]

A second embodiment of the flue gas treatment method according to the present invention will be described with reference to a mode of operation of the second embodiment of the flue gas treatment system having the above-described configuration. Processes similar to those of the first embodiment will not be repeatedly described below.

The flue gas treatment method according to the present embodiment is a flue gas treatment method of treating a combustion flue gas in a low-grade fuel-fired power generation plant, and at least includes a third addition process of further adding NH₃ and/or CaCO₃ as a third additive to the combustion flue gas containing SO₃ remaining in the combustion flue gas before the dust collection process. For the third addition process, an injection pipe installed in the line L₂ from the air preheater 5 to the precipitator 6 can be used, and the third addition process is performed in L₂ and/or the precipitator 6. For a method of injecting the third additive, a method can be employed in which the third additive is vaporized, then air, inert gas, steam, and the like are added thereto, and the resulting mixture is diluted and then added to the combustion flue gas. The flue gas which has undergone the third addition process is discharged from the stack 9 via the precipitator 6 and/or a line L₇ and the desulfurization apparatus 8 and a line L₈.

According to the present embodiment, the same effects as those of the first embodiment can be exhibited, and also the amount of NH₃, calcium carbonate, and the like to be injected to decrease the concentration of SO₃ in the third addition device 3c and the desulfurization apparatus 8, which are arranged in the subsequent stage, can be reduced. Accordingly, the cost of the chemicals can be reduced.

In the present embodiment, the exemplary system and the method do not include the heat recovery/reheating device 7a and the heat recovery/reheating device 7b; however, the present invention is not limited to this. In the flue gas treatment system and the flue gas treatment method for a low-grade fuel-fired power generation plant also, a heat recovery/reheating device with a configuration similar to that of the first embodiment can be arranged on a back stream side of the precipitator 6 or on a front stream side of the stack. With this configuration also, because the concentration of SO₃ in the flue gas has been decreased, corrosion of metal members such as a heat exchanger provided in the installed heat recovery/reheating device and adhesion and accumulation of lime ashes in the heat recovery/reheating device can be suppressed.

In addition, in the first and the second embodiments, the number of the catalyst layers can be further increased and the catalysts can be regenerated for the plurality of catalyst layers of the denitration apparatus. By increasing the number of the catalyst layers and by regenerating the catalysts, the rate of oxidation of SO₂ in the denitration apparatus increases, and thus the concentration of SO₃ in the combustion flue gas is increased. However, in the present embodiment, denitration can be performed by the second addition device 3b, and SO₃ can be reduced by the second addition device 3b. Further, because the decrease of the amount of reduction of SO₃ can be greater than the increase of the concentration of SO₃ in the flue gas, even if the number of the catalyst layers is increased and the catalysts are regenerated, the concentration of SO₃ can be reduced.

The regeneration of the catalyst can be implemented by a method in which a degraded catalyst is washed with water and a chemical to remove degraded components from the catalyst and the catalyst is then impregnated with active components of the catalyst where necessary, such as vanadium oxide, tungsten oxide, and molybdenum oxide.

In addition, the system of the first and the second embodiments can be optionally a system in which a CO converter is provided, which further includes an oxidation catalyst layer arranged on a front stream side of the denitration apparatus 4. The CO converter is provided in order to perform oxidation treatment on carbon monoxide (CO) generated as unburned fraction of the reductant having been added as the second additive and a byproduct gas thereof. In the system having the configuration described above, it is made possible to take measures for reducing the unburned fraction of the second additive to be newly discharged from a denitration and SO₃ reduction apparatus and the like and CO. A large amount of carbon monoxide (CO) is generated particularly in the low-grade fuel-fired power generation plant according to the second embodiment, and the large amount of CO can be further reduced in the system. Further, the CO converter may be arranged on a back stream side of the air preheater or on a back stream side of the desulfurization apparatus. If the CO converter is arranged in the desulfurization apparatus, sulfurous acid gas absorbed by the desulfurization can be converted into sulfuric acid gas, and thus the efficiency of the desulfurization can be improved. On the other hand, if the CO converter is arranged on a back stream side of the air preheater, CO generated in the air preheater can be reduced and the temperature of the oxidation catalyst layer can be controlled to about 200° C. or less, and thereby reoxidation of SO₂ into SO₃ can be efficiently prevented. Further, the oxidation catalyst arranged in the above-described oxidation catalyst layer can include a carrier constituted by an oxide, a mixed oxide, or a complex oxide of one or more selected from the group consisting of titanic (TiO₂), silica (SiO₂), and alumina (Al2O₃). In addition, the carrier is capable of carrying a catalyst constituted by a first component including one or more selected from the group consisting of platinum (Pt), lead (Pd), ruthenium (Ru), rhodium (Rh), iridium (Ir), and silver (Ag); and a second component which includes at least one compound including elements such as phosphorus (P), arsenic (As), and antimony (Sb). By using the catalyst having the above-described configuration, the above-described effects can be achieved, the denitration effect can be achieved, and an effect of efficiently suppressing oxidation of SO₂ into SO₃ can be achieved.

### EXAMPLES

The effects of the present invention will be shown by more specifically describing the present invention with reference to examples. However, the flue gas treatment system and the flue gas treatment method according to the present invention is not limited by the examples.

### Example 1

The effect of an SO₃ reductant (the second additive) for reducing SO₃ in a flue gas generated under the same conditions as those in the coal-fired power generation plant was examined.

### (Preparation of Catalyst A)

By applying a method which is, basically used in production of a denitration catalyst and publicly known per se, a catalyst A was prepared.

### (SO₃ Reduction Performance and Denitration Performance Test I)

By bench-scale testing in which an actual machine is assumed, two pieces in which three pieces of catalysts A were serially combined were prepared, and the pieces were respectively used as Test Example 1 and Test Example 2. A flue gas with predetermined properties was allowed to flow through the test examples, and the concentration of SO₃ and the concentration of NOₓ were measured at the outlet of the first layer, at the outlet of the second layer, and at the outlet of the third layer of the catalyst layer. In Test Example 1, the SO₃ reductant was not added at the inlet of the catalyst layer, and in Test Example 2, propylene (C₃H₆) was added as the SO₃ reductant. The load of C₃H₆ at the inlet of the catalyst layer was 2:1 by molar ratio of C₃H₆:SO₃. The concentration of SO₃ was analyzed by a deposition titration method after the sampling was done. The test conditions are shown in Table 1 below. In the Table, “AV” denotes the area velocity (total contact area by gas amount/catalyst), and the unit of AV is Nm³/(m²·h), which is denoted by the International System of Units as (m³(normal))/m²·h). Ugs denotes the superficial velocity (flow rate of fluid/cross section of the honeycomb catalyst).

TABLE 1
Test Condition I

| Gas amount | | 17 | m³N/h |
|---|---|---|---|
| Ugs | | 2 | mN/sec. |
| AV | First layer outlet | 24.9 Nm³/(m² · h) | |
| | Second layer outlet | 12.4 Nm³/(m² · h) | |
| | Third layer outlet | 8.30 Nm³/(m² · h) | |
| Gas temperature | | 360° | C. |
| Gas | NOₓ | 150 | ppm |
| properties | SOₓ | 800 | ppm |
| | SO₃ | 10 | ppm |

| | |
|---|---|
| O₂ | 4% |
| CO₂ | 10% |
| H₂O | 10% |
| N₂ | Balance |

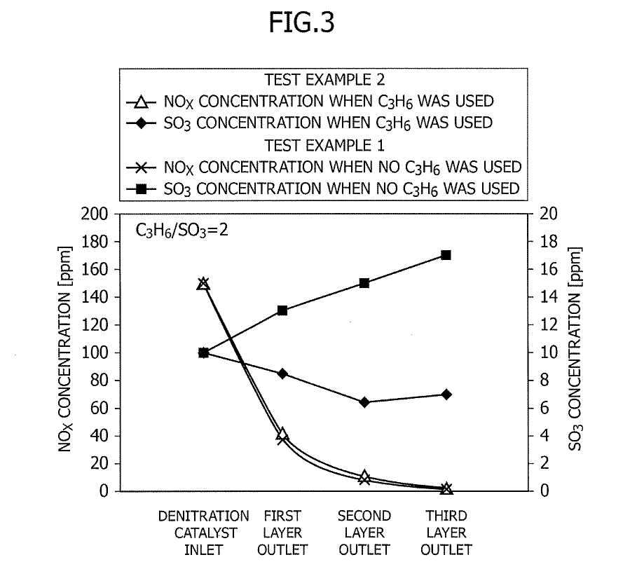

FIG. 3 shows variation of the concentration of SO₃ (ppm) and the concentration of NOₓ (ppm) in the flue gas reduced by the SO₃ reductant when the flue gas was treated under the coal-fired conditions. Referring to FIG. 3, in Test Example 1 and Test Example 2, the concentration of NOₓ in the flue gas decreased from 150 ppm to about 40 ppm at the outlet of the first layer, to about 10 ppm at the outlet of the second layer, and to about 5 ppm at the outlet of the third layer of the catalyst layer. The concentration of SO₃ in the flue gas of Test Example 1 increased from 10 ppm to about 13 ppm at the outlet of the first layer, to about 15 ppm at the outlet of the second layer, and to about 17 ppm at the outlet of the third layer of the catalyst layer. In contrast, the concentration of SO₃ of Test Example 2 decreased from 10 ppm to about 8 ppm at the outlet of the first layer, to about 6 ppm at the outlet of the second layer, and to about 7 ppm at the outlet of the third layer.

It is understood from the above-described results that the same denitration effect as in the case in which C₃H₆ is added to a flue gas treated under coal-fired conditions can be achieved by adding C₃H₆ to the flue gas under the coal-fired conditions for all the regions of AV. In contrast, if no SO₃ reductant is added, the concentration of SO₃ in the flue gas may increase. On the other hand, if C₃H₆ is added to the flue gas treated under the coal-fired conditions as the SO₃ reductant, SO₃ in the flue gas can be reduced and the concentration of SO₃ can be reduced in the regions in which AV is high (i.e., the regions in which the catalyst amount is small) and the regions in which AV is low (i.e., the regions in which the catalyst amount is large).

Next, influences on the actual machine from the concentration of SO₃ in a combustion flue gas in an existing coal-fired power generation plant were examined. Assuming that an air preheater (AH) was installed in an existing coal-fired power generation plant, the continuous operation time was estimated. The continuous operation time was calculated based on the relationship between the concentration of SO₃ in the flue gas and the number of times of washing of the air preheater with water in the same time.

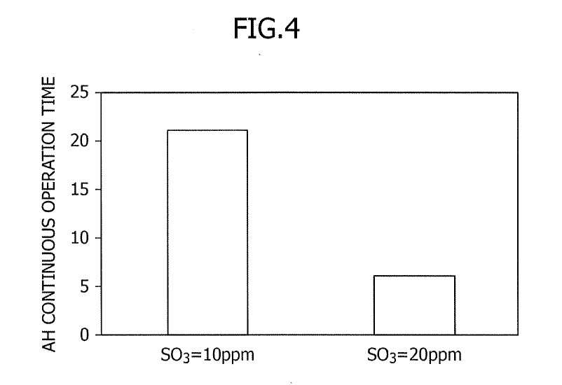

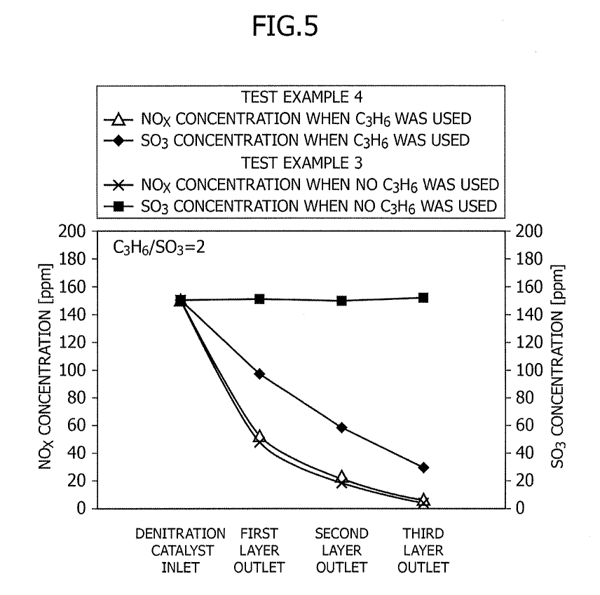

FIG. 4 shows the continuous operation time (months) of the air preheater for different levels of concentration of SO₃ in the flue gas. Referring to FIG. 4, the concentration of SO₃ in the flue gas to which the SO₃ reductant was not added was 20 ppm, and in the case in which the SO₃ reductant was added to the flue gas, the concentration of SO₃ was 10 ppm. In the case in which the concentration of SO₃ in the flue gas was 20 ppm, the continuous operation time for the air preheater was 6 months. In contrast, in the case in which the concentration of SO₃ was 10 ppm, the continuous operation time for the air preheater was 21 months. From these results, it was verified that the continuous operation time for the air preheater could be increased by adding C₃H₆ as the SO₃ reductant, even in an actual machine, by three times or more based on estimation by the past records.

### Example 2

The effect of the SO₃ reductant (the second additive) for reducing SO₃ in a flue gas generated under the same conditions as those in the low-grade fuel-fired power generation plant was examined.

### (SO₃ Reduction Performance and Denitration Performance Test II)

Two pieces in which three pieces of catalysts A were serially combined were prepared, and the pieces were respectively used as Test Example 3 and Test Example 4. In Test Example 3 and Test Example 4, similarly to Example 1, the concentration of SO₃ and the concentration of NOₓ were measured at the outlet of the first layer, at the outlet of the second layer, and at the outlet of the third layer of the catalyst layer. In Test Example 3, the SO₃ reductant was not added at the inlet of the catalyst layer, and in Test Example 4, C₃H₆ was added as the SO₃ reductant. Similarly to Example 1, the load of C₃H₆ at the inlet of the catalyst layer was 2:1 by molar ratio of C₃H₆:SO₃. The test conditions are shown in Table 1 below.

TABLE 2
Test Condition II

| Gas amount | | 19.7 | m³N/h |
|---|---|---|---|
| Ugs | | 2.7 | mN/sec. |
| AV | First layer outlet | 30 Nm³/(m² · h) | |
| | Second layer outlet | 15 Nm³/(m² · h) | |
| | Third layer outlet | 10 Nm³/(m² · h) | |
| Gas temperature | | 360° | C. |
| Gas | NOₓ | 150 | ppm |
| properties | SOₓ | 4000 | ppm |
| | SO₃ | 150 | ppm |

| | |
|---|---|
| O₂ | 2% |
| CO₂ | 10% |
| H₂O | 10% |
| N₂ | Balance |

FIG. 5 shows variation of the concentration of SO₃ (ppm) and the concentration of NOₓ (ppm) in the flue gas reduced by the SO₃ reductant when the flue gas was treated under the low-grade fuel-fired conditions. Referring to FIG. 5, Referring to FIG. 3, in Test Example 3 and Test Example 4, the concentration of NOₓ in the flue gas decreased from 150 ppm to about 50 ppm at the outlet of the first layer, to about 20 ppm at the outlet of the second layer, and to about 5 ppm at the outlet of the third layer of the catalyst layer. The concentration of SO₃ in the flue gas of Test Example 3 increased from 150 ppm to about 150 ppm at the outlet of the first layer, to about 150 ppm at the outlet of the second layer, and to about 155 ppm at the outlet of the third layer of the catalyst layer. In contrast, the concentration of SO₃ of Test Example 4 decreased from 150 ppm to about 95 ppm at the outlet of the first layer, to about 60 ppm at the outlet of the second layer, and to about 30 ppm at the outlet of the third layer.

It is understood from the above-described results that the same denitration effect as the case in which C₃H₆ is added to a flue gas treated under low-grade fuel-fired conditions can also be achieved by adding C₃H₆ to the flue gas under the low-grade fuel-fired conditions for all the regions of AV. In contrast, if no SO₃ reductant is added, the concentration of SO₃ in the flue gas may increase. On the other hand, if C₃H₆ is added to the flue gas treated under the low-grade fuel-fired conditions as the SO₃ reductant, SO₃ in the flue gas can be reduced and the concentration of SO₃ can be reduced in the regions in which AV is high (i.e., the regions in which the catalyst amount is small) and the regions in which AV is low (i.e., the regions in which the catalyst amount is large).

Next, influences on the actual machine from the concentration of SO₃ in a combustion flue gas in an existing low-grade fuel-fired power generation plant were examined. Assuming that a dry type electric precipitator (EP) was installed in an existing coal-fired power generation plant, the continuous operation time was estimated. For the EP, the continuous operation time was calculated based on the relationship between the concentration of SO₃ in the flue gas and the number of times of accumulated ash removal operations.

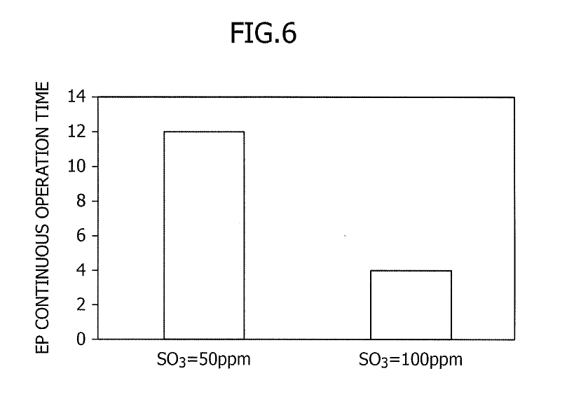

FIG. 6 shows the continuous operation time (months) of the electric precipitator for different levels of concentration of SO₃ in the combustion flue gas. Referring to FIG. 6, the concentration of SO₃ in the flue gas to which the SO₃ reductant was not added was 100 ppm, and in the case in which the SO₃ reductant was added to the flue gas, the concentration of SO₃ was 50 ppm. In the case in which the concentration of SO₃ in the flue gas was 100 ppm, the continuous operation time for the electric precipitator was 4 months. In contrast, in the case in which the concentration of SO₃ was 50 ppm, the continuous operation time for the electric precipitator was 12 months. From these results, it was verified that the continuous operation time for the electric precipitator could be increased by adding C₃H₆ as the SO₃ reductant, also in an actual machine installed in the low-grade fuel-fired power generation plant, by about three times or more.

### Example 3

Variation of concentration of SO₃ in a combustion flue gas which occurs due to addition of an SO₃ reductant (the second additive) when the number of denitration layers of the denitration apparatus is increased and the denitration catalysts are regenerated in an existing coal-fired power generation plant was examined.

Assuming that a construction work for increasing the number of the catalyst layers of the denitration apparatus installed in an existing coal-fired power generation plant was performed to additionally install a third denitration layer constituted by a catalyst A, the concentration of SO₃ and the concentration of NOₓ were estimated. Similarly to Example 1, the concentration of SO₃ and the concentration of NOₓ were measured at the outlet of the first layer, at the outlet of the second layer, and at the outlet of the third layer of the catalyst layer. A case in which no SO₃ reductant was added was used as Test Example 5, and a case in which C₃H₆ was added as the SO₃ reductant was used as Test Example 6. The test conditions were similar to those of Example 1 except that the load of C₃H₆ at the inlet of the catalyst layer was 0.5:1 by molar ratio of C₃H₆:SO₃.

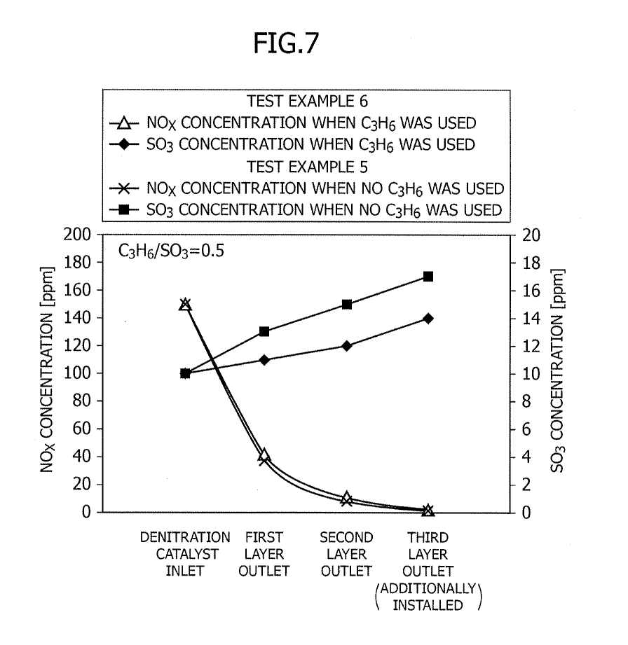

FIG. 7 shows variation of the concentration of SO₃ (%) and the concentration of NOₓ (%) occurring due to addition of the SO₃ reductant when the number of the catalyst layers was increased. Referring to FIG. 7, the concentration of NOₓ of Test Example 5 and Test Example 6 decreased from 150 ppm to about 40 ppm at the outlet of the first layer, to about 10 ppm at the outlet of the second layer, and to about 5 ppm at the outlet of the third layer of the catalyst layer. In addition, the concentration of SO₃ of Test Example 5 was increased from 10 ppm to about 13 ppm at the outlet of the first layer, to about 15 ppm at the outlet of the second layer, and to about 17 ppm at the outlet of the third layer of the catalyst layer. On the other hand, the concentration of SO₃ of Test Example 6 increased from 10 ppm to about 11 ppm at the outlet of the first layer, to about 12 ppm at the outlet of the second layer, and to about 14 ppm at the outlet of the third layer of the catalyst layer.

Subsequently, a degraded catalyst A was regenerated assuming that the number of the catalyst layers of the denitration apparatus in an existing plant had been increased. The regeneration of the catalyst was performed by impregnating vanadium, the active component of the catalyst, after washing the catalyst with chemicals. After the catalyst was regenerated, the concentration of SO₃ and the concentration of NOₓ were measured at the outlet of the first layer, at the outlet of the second layer, and at the outlet of the third layer of the catalyst layer. A case in which no SO₃ reductant was added was used as Test Example 7, and a case in which propylene (C₃H₆) was added as the SO₃ reductant was used as Test Example 8. The test conditions were similar to those of Example 1 except that the load of C₃H₆ at the inlet of the catalyst layer was 0.9:1 by molar ratio of C₃H₆:SO₃.

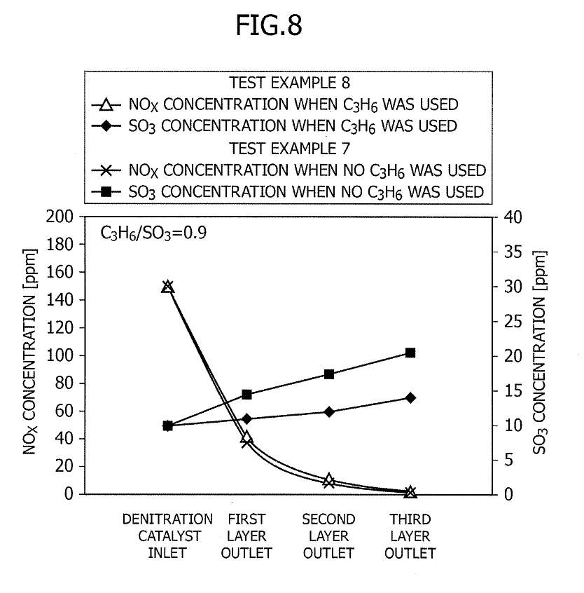

FIG. 8 shows variation of the concentration of SO₃ (%) and the concentration of NOₓ (%) occurring due to addition of the SO₃ reductant after the catalyst regeneration. Referring to FIG. 8, the concentration of NOₓ of Test Example 7 and Test Example 8 decreased from 150 ppm to about 40 ppm at the outlet of the first layer, to about 10 ppm at the outlet of the second layer, and to about 5 ppm at the outlet of the third layer of the catalyst layer. In addition, the concentration of SO₃ of Test Example 7 increased from 10 ppm to about 15 ppm at the outlet of the first layer, to about 17 ppm at the outlet of the second layer, and to about 20 ppm at the outlet of the third layer of the catalyst layer. On the other hand, the concentration of SO₃ of Test Example 8 was increased from 10 ppm to about 11 ppm at the outlet of the first layer, to about 12 ppm at the outlet of the second layer, and to about 14 ppm at the outlet of the third layer of the catalyst layer.

It is known from these results that if the number of the catalyst layers is increased or the catalysts are regenerated in an actual machine, the catalyst amount increases and thus the concentration of SO₃ increases. However, it was verified that increase of SO₃ in the combustion flue gas that might occur due to addition of a catalyst could be prevented by adding C₃H₆ to the combustion flue gas as the SO₃ reductant even in the case in which the number of the catalyst layers had been increased in an actual machine. In addition, it was verified that increase of SO₃ in the flue gas could be prevented by adding C₃H₆ to the flue gas as the SO₃ reductant even if the catalysts had been regenerated in an actual machine.

### Example 4

The effect of the SO₃ reductant (the second additive) for reducing SO₃ into SO₂ was examined for a case of a denitration catalyst with a composition different from the above ones.

### (Preparation of Catalyst B)

As a source of titanium, an aqueous solution of titanyl sulfate in sulfuric acid was prepared, aqueous ammonia was added to water, silica sol was further added thereto, and the previously prepared aqueous solution of titanyl sulfate in sulfuric acid was gradually added dropwise to the solution to obtain TiO₂—SiO₂ gel. The gel was filtered, and the residue was washed with water and then dried at 200° C. for 10 hours. Then the obtained product was fired at 600° C. for 6 hours in an air atmosphere and further crushed by using a crusher, and then classified by using a classifier to obtain a powder body with an average particle size of 10 μm. Ammonium paratungstate ((NH₄)₁₀H₁₀W₁₂O₄₆·6H₂O) was added to and dissolved in a solution of monoethanolamine, then ammonium metavanadate (NH₃VO₃) was dissolved therein to obtain a homogeneous solution. The TiO₂—SiO₂ powder was added to and mixed into this solution, and a honeycomb of 150 mm was formed by extrusion by using an extrusion molding machine.

### (SO₃ Reduction Performance and Denitration Performance Test III)

A case in which the percentage ratio of SiO₂/(TiO₂+SiO₂) of the catalyst B was 5% was used as Test Example 9, and a case in which the percentage ratio of SiO₂/(TiO₂+SiO₂) of the catalyst B was 14% was used as Test Example 10. Similarly to Example 1, two pieces in which three pieces of catalysts B were serially combined were prepared, and the concentration of SO₃ and the concentration of NOₓ were measured at the outlet of the first layer, at the outlet of the second layer, and at the outlet of the third layer of the catalyst layer. In Test Example 9 and Test Example 10, propylene (C₃H₆) was added as an SO₃ reductant. The conditions were the same as those of Example 1.

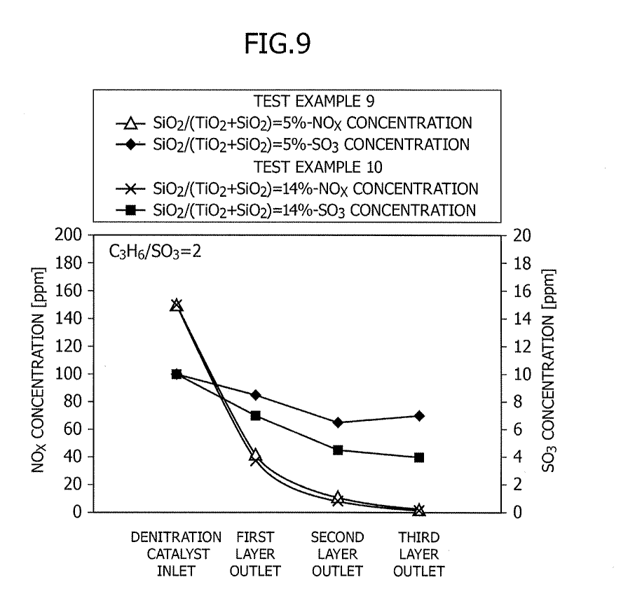

FIG. 9 shows variation of the concentration of NOₓ (%) and the concentration of SO₃ (%) in the flue gas at the respective outlets of the catalyst layer. Referring to FIG. 9, the concentration of NOₓ in the flue gas of Test Examples 9 and 10 decreased from 150 ppm to about 40 ppm at the outlet of the first layer, to about 10 ppm at the outlet of the second layer, and to about 5 ppm at the outlet of the third layer of the catalyst layer. The concentration of SO₃ in the flue gas in Test Example 9 decreased from 10 ppm to about 8 ppm at the outlet of the first layer, to about 6 ppm at the outlet of the second layer, and to about 7 ppm at the outlet of the third layer of the catalyst layer. In contrast, the concentration of SO₃ of Test Example 10 decreased from 10 ppm to about 7 ppm at the outlet of the first layer, to about 4 ppm at the outlet of the second layer, and to about 4 ppm at the outlet of the third layer of the catalyst layer.

### (Analysis of the SO₂ Oxidation Rate)

Then, similarly to the preparation in Test Examples 9 and 10, Test Examples 11 and 12 were newly prepared so that the percentage ratio of SiO₂/(TiO₂+SiO₂) would become 12% and 21%, respectively. Ratios of the SO₂ oxidation rate of Test Examples 9 to 12 were calculated based on the variation of the concentration of SO₃ in cases in which no propylene was supplied, and based on the calculated ratios, ratios of the SO₂ oxidation rate by the variation of the percentage ratio of SiO₂/(TiO₂+SiO₂) were examined.

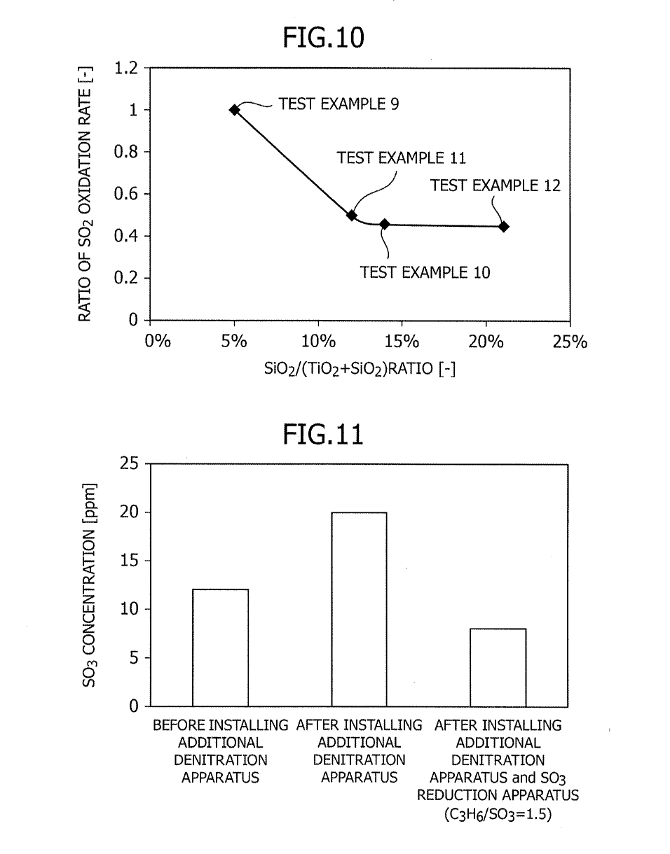

FIG. 10 shows ratios of SO₂ oxidation rate by variation of the percentage ratio of SiO₂/(TiO₂+SiO₂). Referring to FIG. 10, in Test Example 9, in which the percentage ratio of SiO₂/(TiO₂+SiO₂) in the catalyst was 5%, the ratio of SO₂ oxidation rate was 1. On the other hand, in Test Example 11, in which the percentage ratio of SiO₂/(TiO₂+SiO₂) in the catalyst was 12%, the ratio of SO₂ oxidation rate decreased to about 0.5; in Test Example 10, in which the above percentage ratio was 14%, the ratio of SO₂ oxidation rate decreased to about 0.46; and in Test Example 12, in which the above percentage ratio was 21%, the ratio of SO₂ oxidation rate decreased to about 0.45.

From these results, the ratio of SO₂ oxidation rate was lower for the cases in which the percentage ratio of SiO₂/(TiO₂+SiO₂) in the catalyst was 12% to 21% than in the case in which the percentage ratio of SiO₂/(TiO₂+SiO₂) in the catalyst was 5%, and it is understood that the former cases are more preferable in terms of reduction of SO₃. In addition, it is known that the ratio of SO₂ oxidation rate remarkably increases in the range of the percentage ratio of SiO₂/(TiO₂+SiO₂) exceeding 12%. Accordingly, it is understood that if the ratio of TiO₂ in the catalyst is high, the SO₂ oxidation rate becomes high and thus the oxidation reactions quickly progress, and that if the ratio of TiO₂ in the catalyst is high, the concentration of SO₃ in the flue gas is affected. In addition, it is understood that in a denitration catalyst in which the ratio of SiO₂ is high, if the amount of vanadium in the active components is the same, the SO₂ oxidation rate is reduced, and thus the effect of C₃H₆ for reducing SO₃ to SO₂ increases. Further, it is understood that although TiO₂ is a glass fiber component, which is a shape-retaining agent for retaining the honeycomb shape, TiO₂ does not contribute to reduction of the SO₂ oxidation rate, which is implemented by the active components such as vanadium. Accordingly, it is understood that it is necessary to adjust the ratio between TiO₂ and SiO₂ in the solvent separately from adjustment of the load of the SO₃ reductant, and that it is preferable that the percentage ratio of SiO₂/(TiO₂+SiO₂) in the TiO₂—SiO₂ complex oxide be within a range of 5% to 60%, more preferably in the range of 12% to 21%.

### Example 5

Variation of the concentration of SO₃ in a flue gas which occurs due to the SO₃ reductant (the second additive) when a dry type denitration apparatus and an SO₃ reduction apparatus (the second addition device) are additionally installed in an existing coal-fired power generation plant in which no dry type denitration apparatus had been installed until then was examined.

Assuming that a denitration apparatus including a catalyst A and an SO₃ reduction device have been additionally installed in an existing coal-fired power generation plant, the concentration of SO₃ was estimated. The test conditions were similar to those of Example 1 except that the load of C₃H₆ was 1.5:1 by molar ratio of C₃H₆:SO₃.

FIG. 11 shows the variation of the concentration of SO₃ (ppm) across the denitration apparatus in the plant before and after the denitration apparatus and the SO₃ reduction device were additionally installed. Referring to FIG. 11, the concentration of SO₃ before the denitration apparatus was additionally installed was 12 ppm, and the concentration of SO₃ after the denitration apparatus was additionally installed was 20 ppm. The concentration of SO₃ of after the denitration apparatus and the second addition device were additionally installed was 8 ppm.

It was verified from the above results that although the temperature for heat recovery by the air preheater is usually determined in consideration of the heat exchange in the plant, the concentration of SO₃ would increase if a denitration apparatus is additionally installed. Accordingly, the continuous operation of the plant may be affected by the pressure drop which may occur due to corrosion of the air preheater and accumulation of ash. However, SO₃ can be reduced at least in an amount equal to or larger than the amount of increased concentration of SO₃ by additionally installing the second addition device in addition to the denitration apparatus and by supplying C₃H₆ from the front stream of the denitration apparatus. It is known that as a result, it is enabled to continuously operate the plant similarly to the operation of the plant performed before the additional installation of the denitration apparatus.

### Example 6

Next, influences from the SO₃ reductant to the pressure drop, which may occur if the catalyst of the denitration apparatus has degraded and the amount of leaked ammonia corresponding to the part of NOₓ unreacted in the treatment of NOₓ in the coal-fired power generation plant in which the denitration apparatus and the SO₃ reduction device (the second addition device) have been additionally installed, was examined.

In a plant similar to that of Example 5, the concentration of leaked NH₃ and the concentration of SO₃ in the combustion flue gas were measured, and a ratio of increase of the pressure drop inside the air preheater arranged on a back stream side thereof was calculated. In addition, it was assumed that C₃H₆ was periodically supplied from an upstream of the denitration apparatus as the SO₃ reductant to decrease the concentration of SO₃ down to a reference value for the continuous leaked NH₃ or less (e.g., to 3 ppm or less). The amount of leaked NH₃ in the combustion flue gas was measured by an ion chromatographic analysis method, and the concentration of SO₃ was measured by the deposition titration method. The ratio of increase of the pressure drop was determined based on the pressure drop in the measurement target AH.

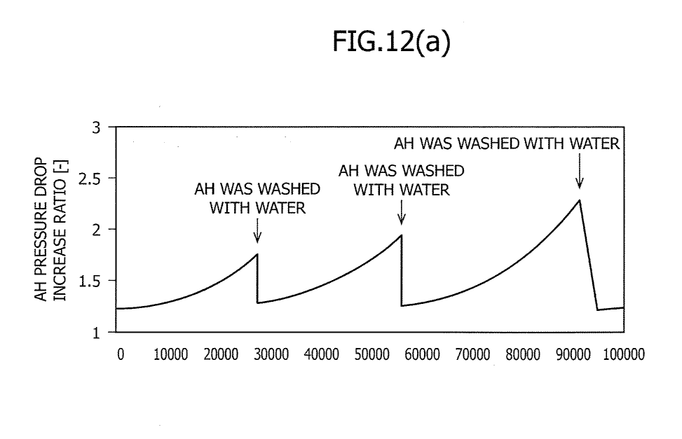

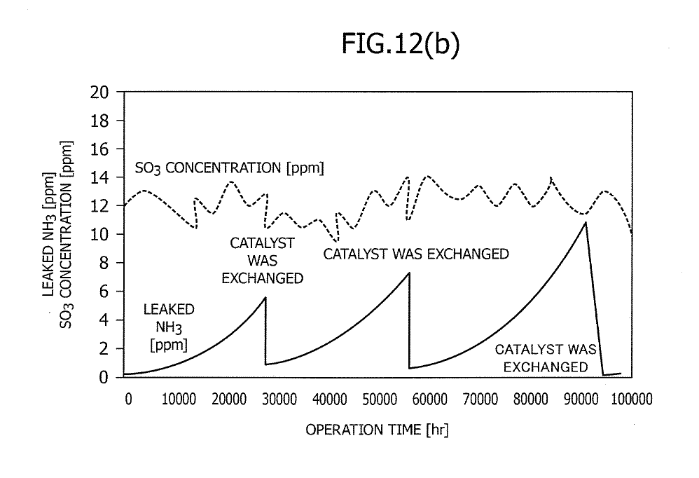

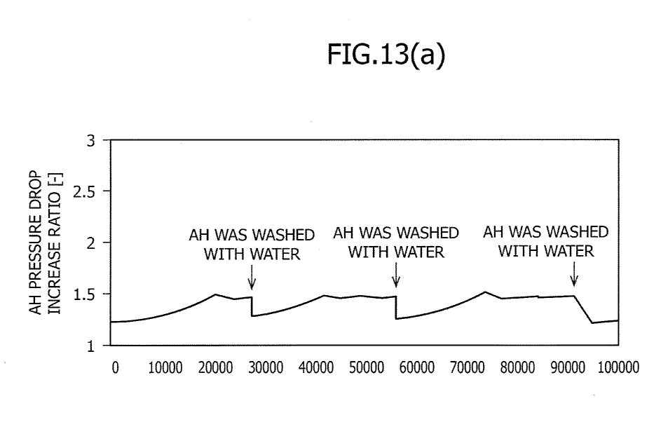

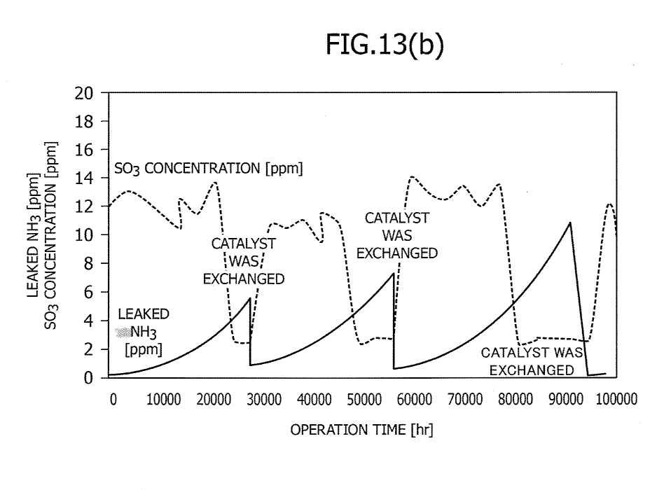

FIG. 12(a) shows the ratio of increase of pressure drop in a conventional plant, and FIG. 12(b) shows the concentration of leaked NH₃ (ppm) and the concentration of SO₃ (ppm) in the conventional plant. FIG. 13(a) shows the ratio of increase of pressure drop in the case in which C₃H₆ were periodically supplied as the SO₃ reductant in the plant, and FIG. 13(b) shows the amount of leaked ammonia (ppm) and the concentration of SO₃ (ppm) in the plant. Referring to FIGS. 12(a) and 12(b), when the amount of leaked ammonia increased, the ratio of increase of the pressure drop in the air preheater increased from about 1.7 to about 2.25, and the air preheater was washed with water. On the other hand, as shown in FIGS. 13(a) and 13(b), even if the amount of leaked ammonia had increased, the concentration of SO₃ was decreased to about 3 ppm by adding C₃H₆, and the ratio of increase of the pressure drop in the air preheater was about 1.5 or less.

If the amount of leaked ammonia generated from the unreacted fraction from the denitration apparatus increases, the leaked ammonia usually reacts with SO₃ concentrated in the combustion flue gas, and thus acid ammonium sulfate is precipitated. The level of accumulated ash in the air preheater abruptly increases mainly due to the precipitated acid ammonium sulfate, and thus the pressure drop may increase. Accordingly, it becomes necessary to stop the plant. However, it is understood from the above result that the amount of SO₃, which is the reaction target matter, can be reduced by installing the second addition device is installed even if the amount of leaked ammonia has increased. With this configuration, precipitation of the acid ammonium sulfate, which may be the main cause of the increase of accumulated ash, can be suppressed. As a result, it was verified that the plant can be stably operated for a long period of time.

### Example 7

Next, variation of the concentration of SO₃ in the combustion flue gas in an existing coal-fired power generation plant in which the denitration apparatus and the SO₃ reduction device (the second addition device) have been additionally installed, which may occur due to variation of the concentration of C₃H₆, was examined.

In a plant similar to that of Example 5, the concentration of SO₃ was measured by a neutralization titration method similarly to Example 5, and based on the measurement values, the effect on the concentration of SO₃ achieved due to varied concentration of C₃H₆ was examined.

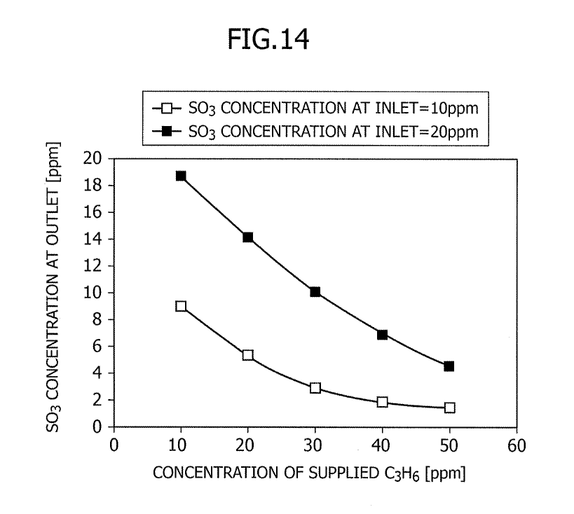

FIG. 14 shows the variation of the concentration of SO₃ (ppm) occurring in relation to various concentration of supplied C₃H₆ (ppm) in the cases in which the concentration of SO₃ at the inlet of the catalyst layer was 10 ppm and 20 ppm. Referring to FIG. 14, when the concentration of SO₃ in the combustion flue gas at the inlet of the catalyst layer was 10 ppm, the concentration of SO₃ at the inlet of the catalyst layer decreased to 9 ppm for the concentration of supplied C₃H₆ of 10 ppm; to about 8 ppm for the concentration of supplied C₃H₆ of 20 ppm; to about 4.5 ppm for the concentration of supplied C₃H₆ of 30 ppm; to about 2 ppm for the concentration of supplied C₃H₆ of 40 ppm; and to about 1 ppm for the concentration of supplied C₃H₆ of 50 ppm. When the concentration of SO₃ in the combustion flue gas at the inlet of the catalyst layer was 20 ppm, the concentration of SO₃ at the inlet of the catalyst layer decreased to 23 ppm for the concentration of supplied C₃H₆ of 10 ppm; to about 18 ppm for the concentration of supplied C₃H₆ of 20 ppm; to about 14 ppm for the concentration of supplied C₃H₆ of 30 ppm; to about 10 ppm for the concentration of supplied C₃H₆ of 40 ppm; and to about 5.5 ppm for the concentration of supplied C₃H₆ of 50 ppm.

It is known from the above results that as the amount of C₃H₆ supplied as the SO₃ reductant is increased (i.e., as the concentration of C₃H₆ is increased), the concentration of SO₃ in the combustion flue gas can be reduced more. It is also known that a more remarkable reduction effect can be achieved for a high concentration of SO₃ at the inlet of the catalyst layer of 20 ppm than for the lower concentration of 10 ppm. In addition, if the concentration of SO₃ at the inlet of the catalyst layer is 10 ppm, the concentration of supplied C₃H₆ is preferably more than 20 ppm, more preferably 30 ppm or more, and yet more preferably 40 ppm to 50 ppm. Further, it is known from these results that if the concentration of SO₃ at the inlet of the catalyst layer is 20 ppm, the concentration of supplied C₃H₆ is preferably more than 10 ppm, more preferably 20 ppm to 50 ppm, yet more preferably 30 ppm to 50 ppm, and particularly more preferably 40 ppm to 50 ppm.

### Example 8

The effect of reducing SO₃ into SO₂ in a catalyst A with respect to the composition of a hydrocarbon compound in the case in which hydrocarbons other than propylene having different compositions were used as the SO₃ reductant (the second additive) was examined.

### Preparation of Test Examples 13 to 20

A case in which methanol (CH₃OH) was used as the second additive was used as Test Example 13, a case in which ethanol (C₂H₅OH) was used as the second additive was used as Test Example 14, and a case in which propane (C₃H₈) was used as the second additive was used as Test Example 15. In addition, a case in which ethylene (C₂H₄) was used as the second additive was used as Test Example 16, a case in which propylene (C₃H₆) was used as the second additive was used as Test Example 17, a case in which 1-butene (1-C₄H₈) was used as the second additive was used as Test Example 18, a case in which 2-butene (3-C₄H₈) was used as the second additive was used as Test Example 19, and a case in which isobutene (iso-C₄H₈) was used as the second additive was used as Test Example 20.

### (SO₃ Reduction Performance Test VI)

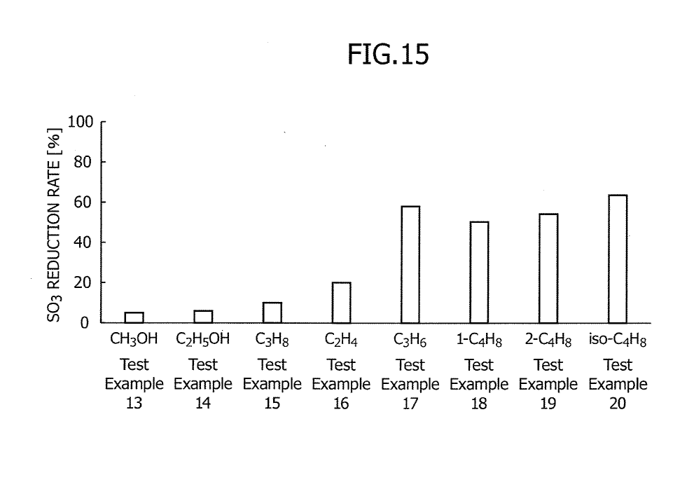

SO₃ reductants with different compositions were added to the combustion flue gas respectively to Test Examples 13 to 20, and the combustion flue gas was allowed to go through the catalyst layers constituted by the SO₃ catalysts and installed in the denitration apparatus and the SO₃ reduction device similar to those in Example 5, and based on the results thereof, variation of the concentration of SO₃ in the combustion flue gas at AV=12.73 N m³/m²·h was examined. The test conditions are shown in Table 3, and the test results are shown in FIG. 15. The concentration of SO₃ was analyzed after the sampling was done, and the SO₃ reduction rate was determined in the following manner. The load of C₃H₆ was 3.6:1 by molar ratio of C₃H₆:SO₃.

SO₃ reduction rate (%)=(1−concentration of SO₃ at catalyst layer outlet/concentration of SO₃ at catalyst layer inlet)×100

TABLE 3
Test Condition III

| Gas amount | | 300 | NL/h |
|---|---|---|---|
| Ugs | | 0.167 | mN/sec. |
| AV | | 12.73 Nm³/(m² · h) | |
| Gas temperature | | 380° | C. |
| Gas | NOₓ | 150 | ppm |
| properties | SOₓ | 3000 | ppm |
| | SO₃ | 100 | ppm |

| | |
|---|---|
| O₂ | 4% |
| CO₂ | 10% |
| H₂O | 10% |
| N₂ | Balance |

FIG. 15 shows the SO₃reduction rate (%) at AV=12.73 Nm³/m²·h in Test Examples 13 to 20. Referring to FIG. 15, the SO₃ reduction rate of Test Example 13 in which alcohols were used was 4%, and the SO₃ reduction rate of Test Example 14 in which alcohols were used was 6%. On the other hand, the SO₃ reduction rate of Test Example 15 in which saturated hydrocarbon was used was 7.2%. The SO₃ reduction rate of Test Example 16 in which saturated hydrocarbon was used was as high a value as 20.2%. Further, the SO₃ reduction rate of Test Example 17 having an allyl structure was 58.4%; the SO₃ reduction rate of Test Example 18 having an allyl structure was 50.2%; the SO₃ reduction rate of Test Example 19 having an allyl structure was 54.2%; and the SO₃ reduction rate of Test Example 20 having an allyl structure was 63.5%, showing very high values.

From the above results, it is understood that the concentration of SO₃ in the combustion flue gas can be more decreased by using C₂H₄, C₃H₆, or C₄H₈, which are a saturated hydrocarbon or an unsaturated hydrocarbon, as the SO₃ reductant, compared with the cases in which alcohols such as CH₃OH and C₂H₅OH were used. It is also understood that among them, C₂H₄, C₃H₆, or C₄H₈, which is an unsaturated hydrocarbon, can be used as the SO₃ reductant to effectively decrease the concentration of SO₃ in the combustion flue gas. In addition, it is understood that concentration of SO₃ in the combustion flue gas can be remarkably decreased by using a ≧3C unsaturated hydrocarbon having an allyl structure as the SO₃ reductant. It was estimated that this was because the decomposition activity of ≧3C unsaturated hydrocarbons having an allyl structure is high and the intermediate body thereof has high reactivity with SO₃.

Next, based on the elementary reaction model on the surface of the catalyst described in the following items 1 to 4, the decomposition activation energy of C₂H₄, C₃H₈, and C₃H₆ as the SO₃ reductant was estimated by molecular simulation.

### 1. Hydrocarbon Adsorption Reaction

Hydrocarbon (CₓH_{y})+surface→CₓH_{y}−surface

### 2. Hydrocarbon Decomposition Reaction (Hydrogen Abstraction Reaction)

CₓH_{y}−surface→CₓH_{y-1} (surface-coordination)+H−surface
   3. Reaction with SO_{3(g)} (Conversion into Sulfonic Acid)
CₓH_{y-1} (surface-coordination)+SO_{3(g)}→SO₂+CₓH_{y-1}−SO₃_{_{——}}H. surface)

### 4. Decomposition of SO₃

CₓH_{y-1}−SO₃_{_{——}}H. surface SO₂+CO₂+CO

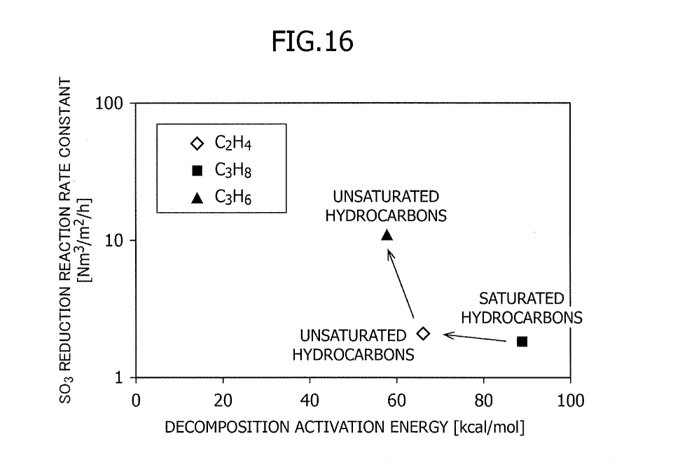

FIG. 16 shows a relationship between the decomposition activation energy (kcal/mol) in hydrogen abstraction reaction from the respective hydrocarbons on the catalyst surface and the SO₃ reduction reaction rate (Nm³/m²/h). Referring to FIG. 16, the SO₃ reduction reaction rate constant of C₃H₈, i.e., a saturated hydrocarbon, was 1.8, and the decomposition activation energy was 89. The SO₃ reduction reaction rate constant of C₂H₄, i.e., a saturated hydrocarbon, was 3.0, and the decomposition activation energy was 65. The SO₃ reduction reaction rate constant of C₃H₆, i.e., a ≧3C unsaturated hydrocarbon having an allyl structure, was 11.2, and the decomposition activation energy was 58.

From the above results, it is known that the SO₃ reduction reaction rate constant for the decomposition activation energy of C₂H₄ has a value higher than that for a saturated hydrocarbon C₃H₈ and that the value of the constant for C₃H₆ is even higher. In addition, it was verified that the decomposition activation energy and the SO₃ reduction reaction rate constant were correlated. It is understood that the above results of Examples were obtained because the double bond in the allyl structure of the SO₃ reductant was easy to decompose. In addition, it is considered that because the decomposition activation energy of the allyl structure is low, hydrogen can be easily abstracted. Accordingly, it was verified that a reductant constituted by an unsaturated hydrocarbon was effective, and that a ≧3C unsaturated hydrocarbon which has an allyl structure was more effective.

### INDUSTRIAL APPLICABILITY

According to the flue gas treatment system and the flue gas treatment method of the present invention, NOₓ in a combustion flue gas can be reduced and the concentration of SO₃ can be reduced more compared with prior art, and a plant can be stably operated for a long period of time.

### REFERENCE SIGNS LIST

1, 10 Flue gas treatment system

2 Boiler

3a First addition device

3b Second addition device

3c Third addition device

4 Denitration apparatus

5 Air preheater

6 Precipitator

7a, 7b Heat recovery/reheating device

8 Desulfurization apparatus

9 Stack

1. A flue gas treatment system which removes NOₓ and SO₃ in a flue gas including NOₓ and SO₃, the system comprising a denitration and SO₃ reduction apparatus configured to simultaneously perform denitration of NOₓ and reduction of SO₃ in the combustion flue gas by adding a first additive and a second additive to the combustion flue gas before bringing the combustion flue gas into contact with a catalyst, and
wherein the first additive is NH₃, the second additive is a 3C-5C olefinic hydrocarbon (unsaturated hydrocarbon), and the catalyst does not include a noble metal.

2. The flue gas treatment system according to claim 1, wherein the second additive is an olefinic hydrocarbon having an allyl structure.

3. The flue gas treatment system according to claim 1, wherein the olefinic hydrocarbon is C₃H₆.

4. The flue gas treatment system according to claim 3, wherein a load of the C₃H₆ is 0.1 to 2.0 by molar ratio of C₃H₆/SO₃.

5. The flue gas treatment system according to claim 1, wherein the catalyst includes an oxide, a mixed oxide, or a complex oxide selected from the group consisting of TiO₂, TiO₂—SiO₂, TiO₂—ZrO₂, and TiO₂—CeO₂ as a carrier.

6. The flue gas treatment system according to claim 5, wherein SiO₂ in the TiO₂—SiO₂ complex oxide is contained within a range of 5% to 60% by a percentage ratio of SiO₂/(TiO₂+SiO₂).

7. The flue gas treatment system according to claim 1, further comprising:
an air preheater arranged on a back stream side of the denitration and SO₃ reduction apparatus and configured to recover heat from the combustion flue gas;
an electric precipitator arranged on a back stream side of the air preheater and configured to collect dust from the combustion flue gas; and
a denitration apparatus arranged on a back stream side of the electric precipitator and configured to absorb and remove SO₂ remaining in the combustion flue gas or obtained by reducing SO₃ by bringing the SO₂ into contact with slurry formed from calcium carbonate.

8. The flue gas treatment system according to claim 7,
wherein the combustion flue gas is a flue gas from a low-grade fuel-fired power generation plant, the system further comprising:
a third addition device arranged on a front stream side of the electric precipitator and configured to further add NH₃ and/or CaCO₃ to the combustion flue gas including SO₃ remaining therein as a third additive.

9. A flue gas treatment method of removing NOₓ and SO₃ in a combustion flue gas including NOₓ and SO₃, the method comprising:
a denitration and SO₃ reduction step of simultaneously performing denitration of NOₓ and reduction of SO₃ in the combustion flue gas by adding NH₃ that is a first additive and a second additive that is a 3C-5C olefinic hydrocarbon (unsaturated hydrocarbon) to the combustion flue gas before bringing the combustion flue gas into contact with a catalyst that does not include a noble metal.

10. The flue gas treatment method according to claim 9, wherein the second additive is an olefinic hydrocarbon having an allyl structure.

11. The flue gas treatment method according to claim 9, wherein the olefinic hydrocarbon is C₃H₆.

12. The flue gas treatment method according to claim 11, wherein a load of the C₃H₆ is 0.1 to 2.0 by molar ratio of C₃H_{6/}SO₃.

13. The flue gas treatment method according to claim 9, wherein the catalyst includes an oxide, a mixed oxide, or a complex oxide selected from the group consisting of TiO₂, TiO₂—SiO₂, TiO₂—ZrO₂, and TiO₂—CeO₂ as a carrier.

14. The flue gas treatment method according to claim 13, wherein SiO₂ in the TiO₂—SiO₂ complex oxide is contained within a range of 5% to 60% by a percentage ratio of SiO_{2/}(TiO₂+SiO₂).

15. The flue gas treatment method according to claim 9, the method further comprising:
an air preheating step of recovering heat from the combustion flue gas that has undergone the denitration and SO₃ reduction step;
a precipitation step of collecting dust from the combustion flue gas that has undergone the air preheating step; and
a denitration step of absorbing and removing SO₂ remaining in the combustion flue gas that has undergone the precipitation step or obtained by reducing SO₃ by bringing the SO₂ into contact with slurry formed from calcium carbonate.

16. The flue gas treatment method according to claim 15,
wherein the combustion flue gas is a flue gas from a low-grade fuel-fired power generation plant, the method further comprising:
a third addition step of further adding NH₃ to the combustion flue gas before being subjected to the precipitation step including SO₃ remaining therein, as a third additive.
